(19) United States
(12) Patent Application Publication
(10) Pub. No.: US 2024/0159641 A1
(43) Pub. Date: May 16, 2024

(54) Throttling Element Particle Detector

(71) Applicant: Inficon, LLC, East Syracuse, NY (US)

(72) Inventors: Shawn Briglin, Cazenovia, NY (US); Nathan Graff, Manlius, NY (US); Silvio Decker, Koln (DE); Michael Haggmark, Manlius, NY (US)

(73) Assignee: Inficon, LLC, East Syracuse, NY (US)

(21) Appl. No.: 18/508,927

(22) Filed: Nov. 14, 2023

Related U.S. Application Data
(60) Provisional application No. 63/425,474, filed on Nov. 15, 2022.

(51) Int. Cl. G01N 15/06

(52) U.S. Cl. CPC G01N 15/06; G01N 2015/0693

(57) ABSTRACT

A particle detector includes at least one throttling element which defines an aerodynamic aperture. A light source illuminates a region of the aerodynamic aperture at about a focal point of an aerodynamic lens. A detector is configured to receive a light scattered from one or more particles which traverse the aerodynamic aperture. A method for detecting and measuring particles previously deposited on a surface of a semiconductor manufacturing chamber is also described.

### REFERENCE TO RELATED APPLICATIONS

This application claims priority to U.S. Provisional Patent Application Ser. No. 63/425,474, filed on Nov. 15, 2022.

### TECHNICAL FIELD

The application (Application) relates to particle detection, particularly to particle detection in pipes that use detection of scattered light.

### BACKGROUND OF THE INVENTION

Particle contaminants in semiconductor fabrication equipment such as plasma etch and vapor deposition chambers can deposit on semiconductor wafer surfaces and cause manufacturing defects that reduce the yield of operable devices. Such small particles typically originate from deposition of a process film onto the process chamber walls. When the film becomes too thick or develops high internal stresses, the film can flake off of the walls forming free particles. If the particles end up on the wafer surface the semiconductor processing process can be adversely affected. In worst case particle contamination of a wafer, part or all of the wafer can no longer be used.

As a result, manufacturers utilize a variety of operational methods and tools to reduce particle contamination in such equipment. Even so, processing a batch of devices can still create particles that cause defects in subsequent batches, and physical maintenance (or cleaning) of the equipment is periodically performed to reduce or eliminate these contaminants. Ideally, physical maintenance is only performed when required to prevent product defect rates from reaching undesirable levels. If physical maintenance is too frequent, down time increases which reduces the total number of devices produced.

Detecting particles early in the wafer manufacturing process is desirable because this information can be used to scrap or rework damaged wafers rather than continue to process wafers with defects. Detecting particles can also be used trigger a chamber clean, which makes uses an etch chemical and plasma to removes thin films from walls before extensive particles can form. Chamber cleans are costly and slow down the process. The chamber, for example, may require a re-seasoning step before continuing. Therefore, it is desirable to clean the chamber no more often than what is required to maintain desirable processed wafer manufacturing yield.

The semiconductor process takes many dozens of steps. A wafer may be processed through many additional and expensive steps after the particles contaminated the surface and degrade yield of the finished devices. Between process steps, particles can be detected by ex situ metrology. However, ex situ metrology detection processes are expensive and can slow down the manufacturing process. Ex situ metrology detection processes are not a perfect representation, because particles can be unintentionally moved off of or onto the wafer in the handling operations. Also, not all particles or particle damage can be detected by ex situ metrology between each wafer processing operation.

In-situ particle monitoring (ISPM) sensors can provide continuous monitoring of particulate contamination levels during key semiconductor process operations and, in many applications, are preferable to ex situ detection. Based upon light-scattering detection techniques, ISPM sensors are typically installed downstream of the process chamber, such as to a pump-line, and provide real-time measurement of variations in particle concentration and size during wafer processing. However, there are several inherent disadvantages to pump-line installation of a sensor apparatus. First, a particle depositing on a processed wafer cannot be measured with the sensor in the pump-line configuration. Second, and because ISPM sensors depend on various particle transport mechanisms to detect the particles generated upstream in the process chamber, ISPM sensor applications often produce poor correlation with the number of particles that deposit directly on the product wafer surface. Third, the particle detection volume for ISPM sensors is also limited by the small cross-sectional area of the laser beam which is illuminating the particle(s). Fourth, measurement typically must be performed at a location far away from the wafer or flat panel being processed. A close in location, such as directly above the wafer seems attractive; however, physical access to space close to the wafer is limited. In addition, semiconductor and flat panel processes often employ plasma, which can cause optical and electrical noise. Moreover, many relevant processes are deposition processes which can quickly degrade sensor windows. Finally, another obstacle is that ports suitable for a scattering measurement are generally not available in suitable positions on existing commercial tools, limiting retrofit options for fabrication equipment in operation.

### SUMMARY OF THE INVENTION

A particle detector includes at least one flow restrictive element or throttling element which defines an aerodynamic aperture. A light source illuminates a region of the aerodynamic aperture at about a focal point of an aerodynamic lens. A detector is configured to receive a light scattered from one or more particles which traverse the aerodynamic aperture. Together the throttling element and particle detector may be referred to as a throttling element particle detector (equivalently, combined throttling element particle detector; combined throttle particle detector; combined valve particle detector; combined aperture particle detector; combined aerodynamic lens particle detector).

A detector is configured to receive a light scattered from one or more particles which traverse the aerodynamic aperture.

A throttling element particle detector can further include a section of pipe. The at least one throttling element can be disposed within the section of pipe. The light source can be mechanically coupled to a wall of the section of pipe and optically coupled via a window to the aerodynamic aperture. The detector can be mechanically coupled to the wall of the section of pipe and optically coupled via a detector window to receive light from one or more particles as they pass through the aerodynamic aperture.

The aerodynamic lens may include a plurality of apertures.

The light source can illuminate substantially all of the aerodynamic aperture. The light source may include a laser light formed into a rectangular ribbon shape of light. The light source can include a laser light formed into a cylindrically-shaped light. The light source can be disposed about adjacent to the at least one throttling element.

The detector can be disposed about adjacent to the at least one throttling element.

The detector can be disposed proximal to the at least one throttling element.

The at least one throttling element can include a series of two or more plates with the aerodynamic aperture defined by the fixed opening. The at least one throttling element can include the aerodynamic aperture defined by a variable aperture device. The variable aperture device can include an iris valve. The variable aperture device can include an iris valve including leaves of the iris valve which curve out of a plane defined by the aerodynamic aperture of the iris valve. The variable aperture device can include a butterfly valve. The variable aperture device can include a gate valve. The variable aperture device can include a vane valve, at least one vane of the vane valve spring biased to a closed position and wherein the at least one vane opens by a gas flow through the vane valve, and wherein in the closed position there remains an open aerodynamic aperture.

The throttling element particle detector can be disposed in gas flow series with a separate main process valve. The throttling element particle detector can be disposed in gas flow parallel with main butterfly valve, the particle detector disposed in a bypass line around a different main process valve.

A throttling element particle detector includes at least one throttling element which defines an aerodynamic aperture. A light source in combination with a scanning minor illuminates a region of the aerodynamic aperture at a focal point of an aerodynamic lens. A detector is configured to receive a light scattered from one or more particles which traverse the aerodynamic aperture.

A method for detecting and measuring particles previously deposited on a surface of a semiconductor manufacturing chamber includes: closing a main pumping valve to induce particle transport including lifting some particles from the surface of the chamber to cause a plurality of lifted particles; opening the main pumping valve and pumping by a vacuum pump to purge the chamber of the plurality of the lifted particles to draw at least some of the plurality of the lifted particles through a throttling element particle detector as sensed particles; and measuring the sensed particles as an indicia of chamber cleanliness status.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1. shows a cross-sectional diagram of a butterfly valve and particle detection system in accordance with embodiments of the present disclosure.

FIG. 2A shows a cross-sectional diagram of a valve and particle detection system in a plane of the optical beam scattering and detection in accordance with embodiments of the present disclosure.

FIG. 2B shows a cross-sectional diagram of a valve and particle detection system in a plane of the optical beam scattering and detection further illustrating the projection of the aerodynamic aperture governing the region of intersection with the light path in accordance with embodiments of the present disclosure.

FIG. 3A shows a projection view of a gate valve in accordance with embodiments of the present disclosure.

FIG. 3B shows a projection view of an iris valve in accordance with embodiments of the present disclosure.

FIG. 4. shows a cross-sectional diagram of a combined adjustable throttle and particle detection system in accordance with embodiments of the present disclosure.

FIG. 5A shows a cross-sectional diagram of a combined adjustable throttle and particle detection system with the projection of the aerodynamic lens aperture onto the region of light scattering produced by the optical system in accordance with embodiments of the present disclosure.

FIG. 5B shows a computation of scattered light intensity as a function of angular distribution predicted by Mie theory and representative parameters in accordance with embodiments of the present disclosure.

FIG. 6 shows a cross-sectional diagram of a gate valve and particle detection system in accordance with embodiments of the present disclosure.

FIG. 7 shows a cross-sectional diagram of a combined adjustable throttle and particle detection system with a spring-loaded limiting feature as the throttling element in accordance with embodiments of the present disclosure.

FIG. 8. shows a cross-sectional diagram of a combined adjustable throttle and particle detection system in accordance with embodiments of the present disclosure.

FIG. 9 shows a cross-sectional diagram of a gate valve and particle detection system incorporating an exemplary gas puff process for cleaning the optical ports in accordance with embodiments of the present disclosure.

FIG. 10 shows an exemplary process for sampling and sensing particles as an indicium for the processing chamber cleanliness status in accordance with embodiments of the present disclosure.

FIG. 11 is an exemplary diagram illustrating features of a processing system used to control a combined valve and particle detection system in accordance with embodiments of the present disclosure.

### DETAILED DESCRIPTION

Small particles are problematic in modern semiconductor and display manufacturing. These particles often ranging from <10 nm to >500 nm and typically originate from deposition of the process film onto the process chamber walls. When the films become thick or develop high internal stress, they can begin to flake off of the walls forming free particles. If the particles end up on the wafer surface this can adversely affect the semiconductor processing process.

In situ particle detection is a desirable approach to monitoring the cleanliness status of a semiconductor or display manufacturing process chamber. Some examples of in situ particle detection use lasers.

Most modern semiconductor processes operate between high vacuum (for example, ≤0.0001 Torr) and low vacuum (for example, 0.1 Torr to 100 Torr) conditions. Under high vacuum conditions, the chamber connection is opened fully to a pump. High vacuum is best to remove residual species from a previous process or after a routine or preventative maintenance cycle. However, low vacuum is necessary to maintain the process conditions suitable for sputtering or plasma facilitated processes of most modern deposition and etch processes. To maintain vacuum, the process chamber is typically connected to a vacuum pump. The connection typically makes use of a variable throttle valve to adjust the pumping speed and maintain the desired process pressure in the chamber.

In situ particle detection typically utilizes a low-divergence light source to generate a directed light beam to produce scattered light when impinging upon particles for sensing purposes. Low-divergence light sources include gas lasers, solid-state lasers fiber lasers, liquid or dye lasers, semiconductor lasers (laser diodes), low-divergent LED (light-emitting diode). Laser optical light sources are specifically mentioned. In the present disclosure, the term “light source” refers to a low-divergence source of light including, but not limited to, a laser light source.

A scanning laser or fanned out beam of a higher power laser are two suitable approaches for in situ particle detection. Light from a light source is scattered from the particle and detected with a suitable photon sensitive device. The photon device can be any suitable detector, such as, for example, a photo multiplier tube (PMT), an avalanche photo diode (APD), or a camera (for example, a camera based on a CMOS array). The most probable direction of scattered light can be predicted by particle size, particle make-up (index of refraction), and the laser wavelength, for example, as described by the Mie scattering theory. Particle detectors have been described, for example, in U.S. Pat. Nos. 6,906,799, 5,943,130, and 10,801,945, all of which are incorporated herein by reference in their entirety for all purposes.

Piping may be use to connect the processing chamber through various throttle valves, sensors, controls and actuators to a vacuum pump used to evacuate the chamber. Where piping allows, a laser-based particle sensor can be mounted on the chamber's exhaust line (equivalently, the fore line or the pump line). Installation of a particle detection system on the pump line or fore line can be advantageous because the sensor can be added to a complete semiconductor tool, or a range of tools, with minimal modification. A concern for installation of particle sensor on an exhaust line is, that the measured particle flux passing through a region of the fore line may not be well correlated with the particles that damage the wafer. As the distance from the wafer to the sensor increases, this correlation decreases further because particles fall out of the gas flow due to gravity, sticking, or other mechanisms. Additionally, the particle flux falls, as the gas flow moves through larger diameters of the exhaust lines.

High particle flux near the throttle valve can be a preferred place to do detection. However, installation below the throttle valve is problematic because the regions of highest particle density change as the throttle valve is actuated. The main throttle valve is typically controlled with a feedback loop to maintain a target process pressure, which can cause noise in the measurement and missed particles.

### Throttling Element Particle Detector

It has been surprisingly discovered by the inventors that combining a particle detection system proximal to a throttling element can mitigate or eliminate many previously known disadvantages pertaining to in situ particle detectors.

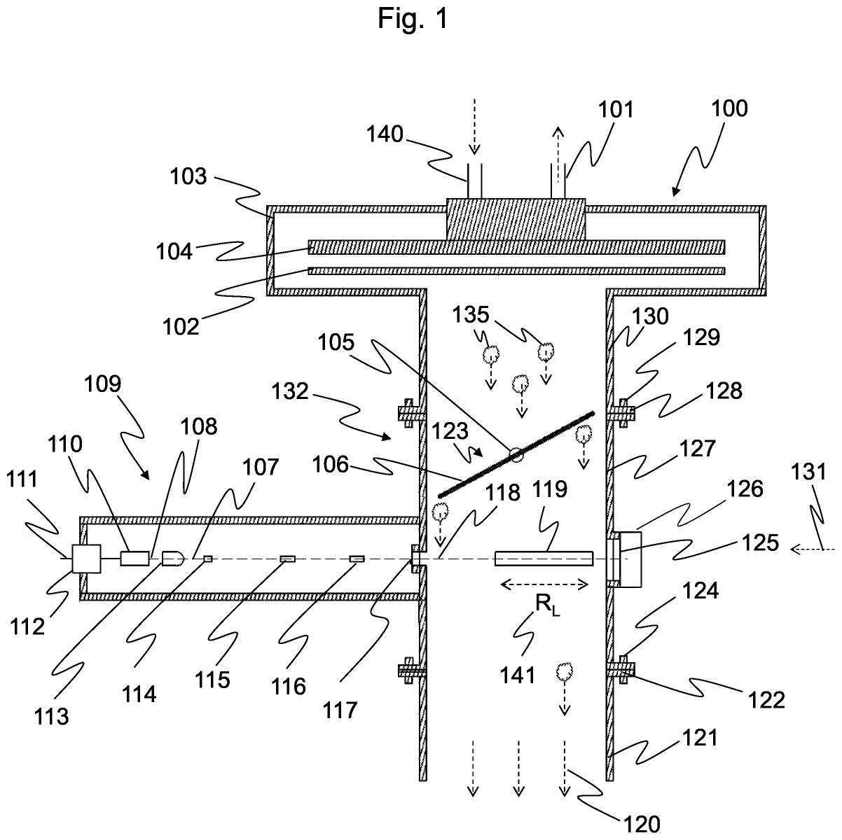

FIG. 1 illustrates an embodiment of a particle detector directly mounted proximal or adjacent to a flow restrictive element, also called a throttling element. This configuration allows matching the size of the illuminating light from a low-divergence light source to the aerodynamic aperture of a throttling element to achieve a high counting efficiency of most or substantially all of the particles traveling through the illuminated area.

FIG. 1 shows an exemplary embodiment longitudinal cross-sectional drawing of a combined throttling element particle detector 132 disposed and in communication with a process chamber 100 and fore line piping 121 of a process tool. Process gas is introduced into the process chamber 100 through one or a plurality of inlets 140 and some gas may be removed through chamber outlets 101 in conjunction with the process chamber deposition apparatus 104 in the process chamber housing 103. Deposition occurs on the surface of a wafer 102 in a process that may shed unwanted particles 135 which may be dislodged and flow into the process chamber piping 130 by a flow 120 induced by a vacuum pump (not shown) used to evacuate process gas from the process chamber 100. In the displayed embodiment, a combined throttling element particle detector 132 is disposed in fluidic communication between the process chamber piping 130 and the fore line piping 121 and may be secured by any practical means including, for example, by a combination of one or a plurality of flanges 128 and fasteners 129 to the process chamber piping 130 and a combination of one or a plurality of flanges 122 and fasteners 124 to the fore line piping 121. In the embodiment illustrated in FIG. 1, the combined throttling element particle detector 132 comprises a housing 127, which may be a section of pipe or tubing or other suitably equivalent enclosure. A throttling element is disposed in the housing 127, in this embodiment shown as a butterfly valve 123 with a rotating disk 106 and a shaft 105.

An optical particle detection system comprising an optical transmitter 109 and optical receiver (not shown) are disposed in optical communication with the combined throttling particle detector fixed to the housing 127. A light source 110 in communication with an outside through a conductor 112 and a connector 111 is secured in the optical transmitter. Light 108 emitted by the light source 110 traverses a series of optical components; for example, in the embodiment shown in FIG. 1, light passes through a sequence of lenses 113 and mirrors 114, such as a Powell lens 115 and a cylindrical lens 116, designed to focus and shape the light beam into a column that passes into the housing of the combined throttling element particle detector housing 127 through an optical window 117. The shaped light may be of any suitable for particle detector. A rectangular shape is specifically mentioned. A rectangular light beam shape with a narrow longitudinal height about parallel to the flow of particles in the gas through the housing 127 is between 0.2 millimeter (mm), or 0.4 mm, or 0.6 mm, or 1.2 mm or 1.4 mm or 1.6 mm, or 1.8 mm or 2 mm, or 3 mm or 4 mm, or 5 mm to 6 mm, or 8 mm, or 10 mm, or 12 mm, or 16 mm, or 18 mm, or 20 mm, or 30 mm, or 40 mm or 50 mm. The foregoing upper and lower bounds can be independently combined. Rectangular beam widths of approximately 1 mm, 5 mm, 10 mm and 20 mm are specifically mentioned. A rectangular light beam shape with a cross-sectional width about orthogonal to the flow of particles in the gas through the housing 127 is between 1 centimeter (cm), 2 cm, 3 cm, 4 cm, 5 cm, 6 cm, 7 cm, 8 cm, 9 cm, 10 cm to 12 cm, 14 cm, 16 cm, 18 cm, 20 cm, 30 cm, 40 cm or 50 cm. The foregoing upper and lower bounds can be independently combined. Approximate rectangular beam widths of 5 cm, 10 cm, 20 cm and 30 cm are specifically mentioned. The shaped light beam passed through the optical window 117 in the light beam path 118 into the housing 127 and past an optical window 119 of the optical receiver. The optical window 119 is designed to have a shape consistent with receiving light scattered by particles traversing the region proximal to the receiver optical window 119 with a window width 141, R_{L}, selected according to the design dimensions of the aerodynamic aperture of the throttling element 123. Opposite the optical transmitter window 117 is disposed an optical window 125 for receiving unscattered light from the optical transmitter 109 to a beam dump 126 or equivalent device for absorbing light energy.

A first aspect is that the combined throttling element particle detector is removable as a unit for installation, periodic or diagnostic maintenance, or replacement. Removable mounting apparatus, such as the such as the flange 128 and fastener 129 depicted in FIG. 1 connecting the housing 127 to the process chamber piping 130, and the flange 122 and fastener 124 depicted in FIG. 1 connecting the housing 127 fore line piping 121 support both retrofit of existing operational semiconductor tools and well and new tool designs specifically incorporating an embodiment of the Application.

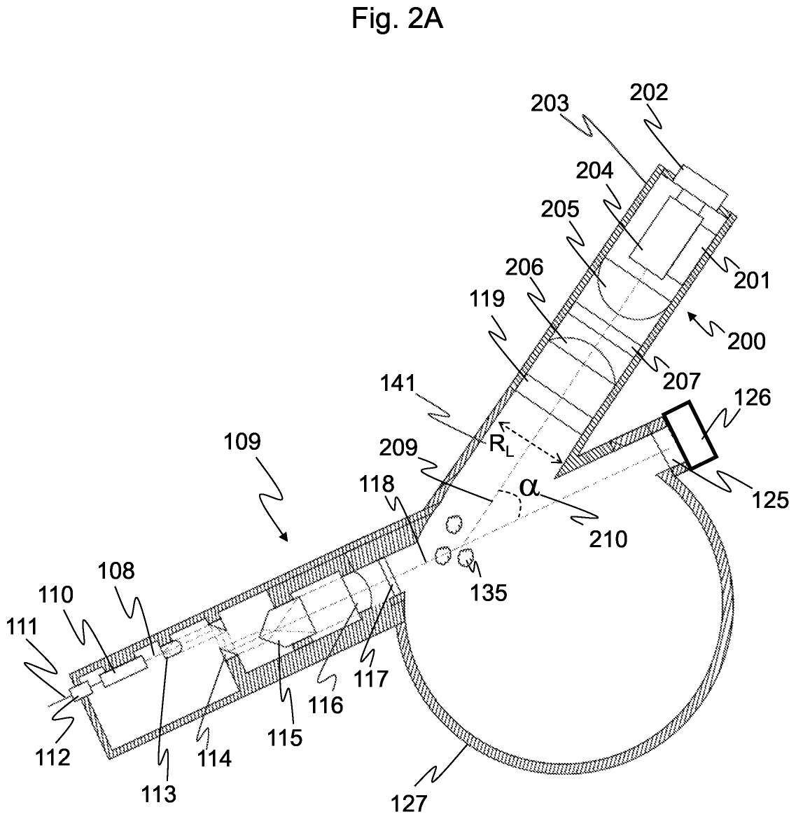

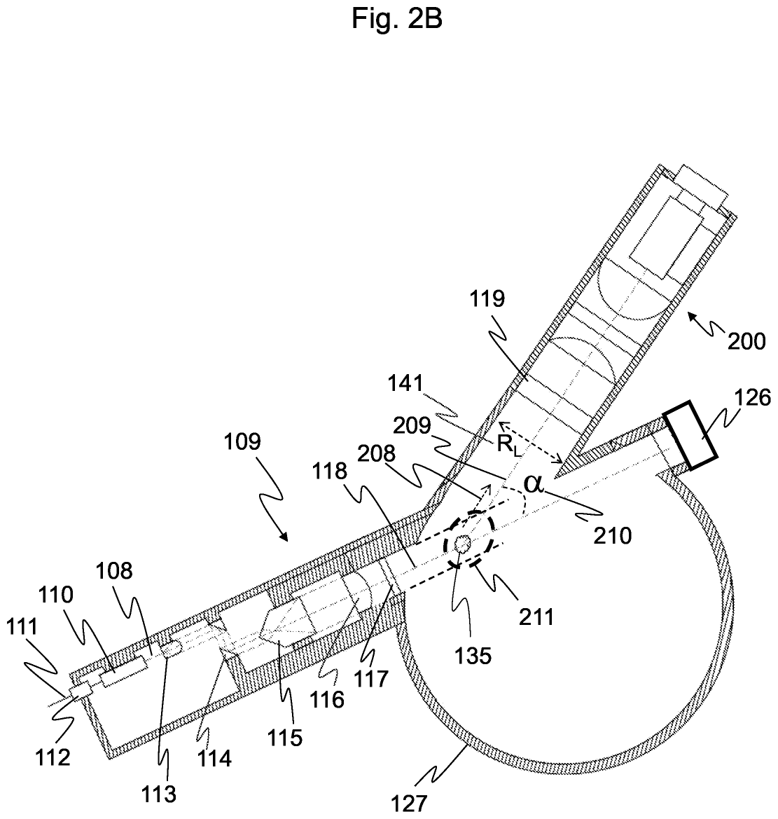

FIG. 2A shows a cross-sectional diagram of the combined throttling element particle detector shown in FIG. 1 in the plane 131 of FIG. 1 about orthogonal to the gas flow direction and coinciding with the optical plane formed by the optical transmitter 109, optical receiver 200 and beam dump 126. A light source 110 in communication with an outside through a conductor 112 and a connector 111 is secured in the optical transmitter. Light 108 emitted by the light source 110 traverses a series of optical components; for example, in the embodiment shown in FIG. 2A, light passes through a sequence of lenses 113 and minors 114, such as a Powell lens 115 and a cylindrical lens 116, designed to focus and shape the light beam into a rectangular column that passes into the housing of the combined throttling element particle detector housing 127 through an optical window 117. Light 118 traversing the housing 127 may be scattered at about an angle 210, α, by particles 135 carried by the evacuating process gas passing through the throttling element particle detector and diverted along a path 209 to the optical receiver 200 through an optical window 119 in the optical receiver 200 disposed on the housing 127.

The receiver optical window width 141, R_{L}, is selected according to the design dimensions of the aerodynamic aperture of the throttling element (not shown). Scattered light 209 enters the receiver and passes through optical elements possibly including, but not limited to, lenses 206, optical filters 207, collector optics 205 to the optical detector 204 secured 201 to the housing 203 of the optical receiver 200. Signals from the optical detector 204 are transmitted to an outside through a connector 202 for processing.

FIG. 2B shows the cross-sectional diagram of the combined throttling element particle detector shown in FIG. 2A about orthogonal to the gas flow direction and coinciding with the optical plane formed by the optical transmitter 109 and beam dump 126 shown in FIG. 1, and an optical receiver 200. A light source 110 in communication with an outside through a conductor 112 and a connector 111 is secured in the optical transmitter. Light 108 emitted by the light source 110 traverses a series of optical components; for example, in the embodiment shown in FIG. 2B, light passes through a sequence of lenses 113 and mirrors 114, such as a Powell lens 115 and a cylindrical lens 116, designed to focus and shape the light beam into a rectangular column that passes into the housing of the combined throttling element particle detector housing 127 through an optical window 117.

The light emitted by the light source 110 is fanned out with by a Powell lens 115 to create a flat-top intensity profile which is then recollimated with a cylindrical lens 116 to form a ribbon of light 118. The ribbon of light 118 width is optimally about equal to, or just wider than the cross-sectional area of the throttling element at the targeted process step to be monitored. In this way photons are not wasted, meaning that only photons capable of generating a particle scattering event are introduced. Matching the ribbon of light to the aerodynamic aperture reduces unnecessary and undesirable scattering off of the walls, windows, and beam dump any of which can cause an increased background noise. Similarly, particles are not wasted, meaning that particles are not allowed to pass through the device without passing through the laser beam. It can be appreciated that the throttling feature serving as an aerodynamic lens is approximately the smallest region where a laser ribbon can be guaranteed to intercept substantially all flow passing through, for example, a fore line pipe and to ensure that particle scattered photons are in a region illuminated by the ribbon of light 118.

Any suitable detector can be used, such as, for example, the exemplary photo multiplier tube (PMT) 110 of FIG. 2B. The detector can be mounted to a wall of the housing 127. Any suitable optical window can be used where the detector can receive light scattered from particles passing through the aperture of the aerodynamic lens.

A beam dump 126 absorbs light radiation from the light source to avoid excess light scattering that might be seen by the detector. The beam dump 126 can be mounted to a wall of the housing 127. Any suitable type of beam dump can be used.

Light 118 traversing the housing 127 enters a volume formed by the intersection of the shaped light column 118 and the aerodynamic lens guiding the gas and particle flow according to the type, geometry, and placement of the throttling element, such as the butterfly valve 123 depicted in FIG. 1. Withing the region defined by this intersection, may be scattered at about an angle 210, α, by particles 135 carried by the evacuating process gas passing through the throttling element particle detector and diverted along a path 209 to the optical receiver 200 through an optical window 119 in the optical receiver 200 disposed on the housing 127. In the case of the butterfly valve 123 shown in FIG. 1, the gas and particle flow occur around the disk 106 of the butterfly valve 123, between the edges of the butterfly valve disk 106 and an inside wall of the housing 127. As a result, to produce scattered light to be received by the optical receiver 200, the optical transmitter 109 must be disposed on the housing 127 so that the transmitted light beam passes about adjacent to the housing 127 wall.

A second aspect is that one or a plurality of aerodynamic apertures can be used to improve the collection of scattered light delivered to an optical receiver. It has been surprisingly discovered by the inventors that use of one or a plurality of aerodynamic apertures can shape and focus the path of the process gas carrying the particles 135 into a region 211 or light scattering zone 211, located within the housing 127 to optimize the collection of scattered light 208 by the optical receiver 200.

A throttling element of the combined throttling element particle detector can be a primary valve, such as a valve that replaces a traditional butterfly valve disposed between a process chamber and a vacuum pump, often a turbo molecular pump. Or, the throttling element and sensor can be disposed in a gas flow line in series gas fluid flow with a main valve, such as, for example a traditional main butterfly valve. Or, the throttling element and sensor can be disposed in a gas flow line in parallel gas fluid flow with a main valve, such as, for example as a bypass line and device in bypass with a traditional main butterfly valve.

The throttling element can be a fixed aerodynamic aperture; for example, a plate with a fixed size hole, a tube, or one or more fixed apertures in series gas flow. Alternatively, the throttling element can be a variable aerodynamic aperture; such as, for example, an iris valve (two-dimensional or with a three-dimensional variable or movable wall structure) or a gate valve, or a functional equivalent. A butterfly valve, iris valve and gate valve are specifically mentioned. Any suitable fixed or variable throttling element aerodynamic aperture, and combinations thereof (fixed and variable) can be used. The aerodynamic aperture can also be an orifice in a plate, cone, funnel or other apparatus used to direct, constrain, control and focus an aerodynamic flow.

Any suitable illumination can be used to illuminate the aerodynamic aperture of the throttling element. In embodiments, a laser light can be used where the laser light is either scanned to substantially match the shape of the aerodynamic aperture, or formed to fill the aerodynamic aperture. The illumination can be either scanned or formed or shaped (for example, to the shape of a ribbon or cylinder of light) to substantially match the aerodynamic aperture both to illuminate particles that might pass through the aerodynamic aperture. The scanned light or beam formed light (or, combinations thereof) can be sized to minimize or to substantially eliminate illumination of surfaces of a throttling element which are outside of the aerodynamic aperture to reduce light scattered from fixed surfaces of the valve and any surrounding structure such as the inside of the fluid pipe. The pipe is typically any suitable gas flow pipe or vacuum pipe suitable to the range of gas pressure being used in the particular semiconductor manufacturing process. By covering the aerodynamic aperture of the flow restrictive element where the size of the illumination light is substantially matched to the size of aerodynamic aperture, a high counting efficiency can be achieved because all or almost of all of the particles are traveling through the light, often a laser light in semiconductor process applications.

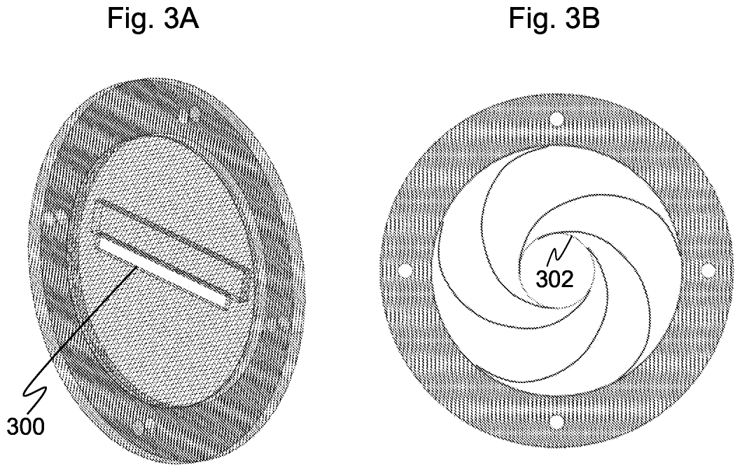

FIG. 3A displays a perspective drawing of a gate valve with an adjustable opening 300 accordance with embodiments of the present disclosure. FIG. 3B displays a perspective drawing of an iris valve with an adjustable opening 302 accordance with embodiments of the present disclosure.

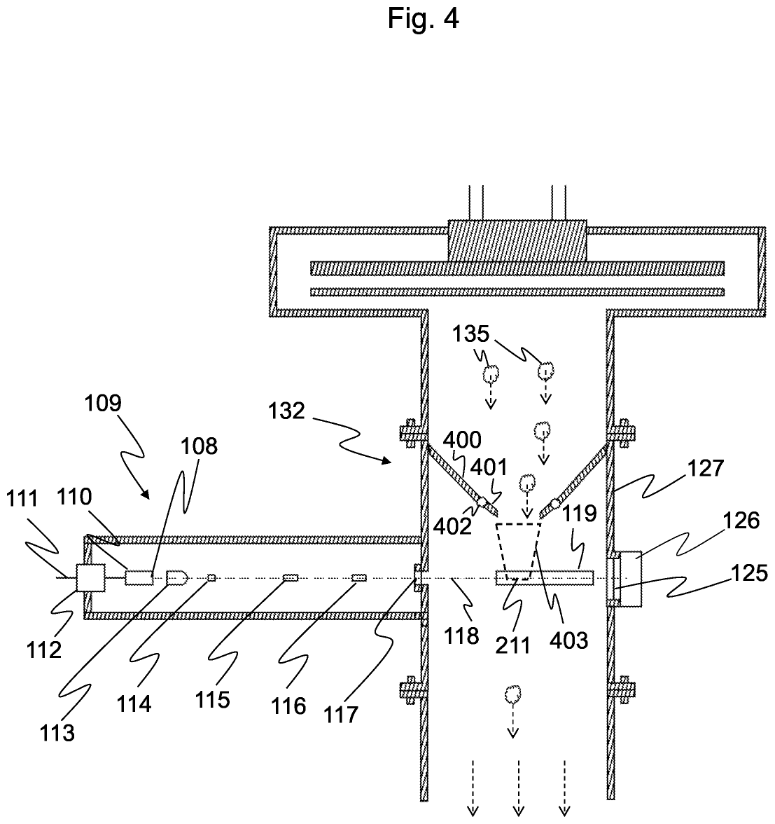

FIG. 4 shows an exemplary embodiment longitudinal cross-sectional drawing of a combined throttling element particle detector 132. A throttling element is disposed in the housing 127, in this embodiment shown as an aerodynamic aperture with a conical housing 400 and an adjustable member 401 articulated at an adjustable fitting 402 that enables a changeable aperture. An optical particle detection system comprising an optical transmitter 109 and optical receiver (not shown) are disposed in optical communication with the combined throttling particle detector fixed to the housing 127. A light source 110 in communication with an outside through a conductor 112 and a connector 111 is secured in the optical transmitter. Light 108 emitted by the light source 110 traverses a series of optical components; for example, in the embodiment shown in FIG. 4, light passes through a sequence of lenses 113 and mirrors 114, such as a Powell lens 115 and a cylindrical lens 116, designed to focus and shape the light beam into a column that passes into the housing of the combined throttling element particle detector housing 127 through an optical window 117. The optical window 119 is designed to have a shape consistent with receiving light scattered by particles traversing the region proximal to the receiver optical window 119 with a window width selected according to the design dimensions of the aerodynamic aperture of the throttling element 401. Opposite the optical transmitter window 117 is disposed an optical window 125 for receiving unscattered light from the optical transmitter 109 to a beam dump 126 or equivalent device for absorbing light energy.

The adjustable aperture 401 generates an aerodynamic lens 403 with a focal point 211 proximal to the rectangular light path 118 emanating from the optical transmitter 109. The spatial intersection between the aerodynamic lens 403 near its focal point 211 produces a scattering zone that, by design, improves the collection of light scattered by particles 135 traversing the aperture formed by the adjustable aperture 401 and entering the scatter zone near the aerodynamic leans focal point 211.

Any suitable aerodynamic aperture or valve (for example, adjustable iris FIG. 3A) can be used, including, an electrically adjustable valve incorporating a motor, or stepper motor, or pneumatic actuator, as illustrative examples.

Any suitable illumination light source can be used, including a laser diode. Any suitable optics package can be used, including for example, optical elements which cause light dispersion of a laser diode package, and/or additional lenses and/or mirrors and combinations thereof. A cylindrical shape of light can be used as an alternative to a ribbon of light (with about a rectangular cross section). A cylindrical light can be made brighter towards the center of the about round cross section in about a Gaussian distribution of light intensity. A Gaussian distribution of light intensity may be desirable, as compared to a substantially uniform light flux of photons, where more particles (higher particle density) are expected to be closer to the center of the aerodynamic aperture of the aerodynamic lens.

Any suitable optics components or optics assembly can be used to form a shaped beam from the light source. Suitable optical components and methods include, for example, a cylindrical lens, a divergent laser diode package, a cylindrical lens for cylindrical shaped beam, a multipath configuration, one or more curved mirrors, and combinations thereof. A multipath configuration can be well suited to cover a larger area aerodynamic aperture.

A scanning light, such as a scanning laser light can also be used to create any desired illumination coverage of an aerodynamic aperture over the scanning time. The scan can be configured to match any suitably shaped aerodynamic aperture including, for example, square, rectangular, circular and elliptical openings, or combinations thereof.

For applications where higher conductance is desired, the collimating cylindrical lens can be adjusted to make a wider ribbon, such as, for example, by using a linear translation stage or an electrically tunable lens to make the ribbon wider to better match the larger aerodynamic beam.

One or a plurality of throttling elements can be used to provide a multistage aerodynamic lens. Moreover, the throttling element geometry can help to keep gas flow and particles away from the illumination and detection windows. Furthermore, a combined throttling element particle detector according to the Application can replace a primary throttle valve in a semiconductor manufacturing process tool.

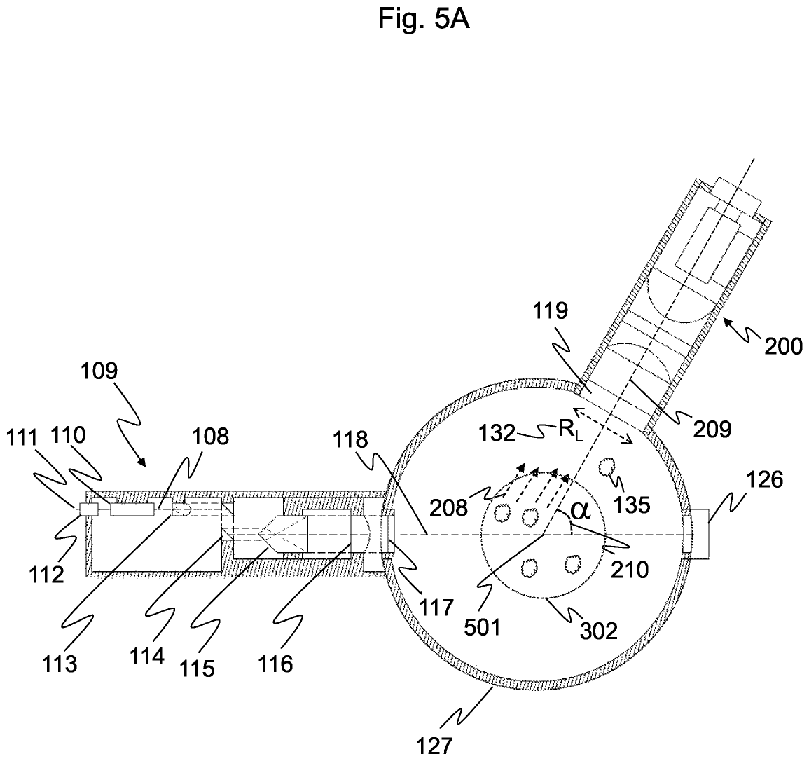

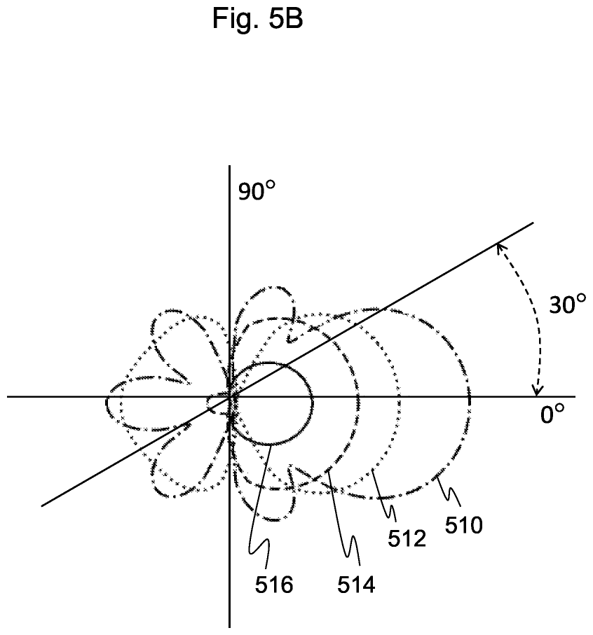

FIG. 5A shows a cross-sectional diagram of the combined throttling element particle detector shown in FIG. 4 about orthogonal to the gas flow direction and coinciding with the optical plane formed by the optical transmitter 109 and beam dump 126 shown in FIG. 1, and an optical receiver 200. A light source 110 in communication with an outside through a conductor 112 and a connector 111 is secured in the optical transmitter. Light 108 emitted by the light source 110 traverses a series of optical components; for example, in the embodiment shown in FIG. 5A, light passes through a sequence of lenses 113 and minors 114, such as a Powell lens 115 and a cylindrical lens 116, designed to focus and shape the light beam into a rectangular column that passes into the housing of the combined throttling element particle detector housing 127 through an optical window 117.

Light 118 traversing the housing 127 enters a volume formed by the intersection of the shaped light column 118 and the aerodynamic lens guiding the gas and particle flow according to the type, geometry and placement of the throttling element, such as the adjustable aperture 401 depicted in FIG. 4. Withing the region defined by this intersection, may be scattered at about an angle 210, α, by particles 135 carried by the evacuating process gas passing through the throttling element particle detector and diverted along a path 209 to the optical receiver 200 through an optical window 119 of length 141 RL in the optical receiver 200 disposed on the housing 127. In the case of the adjustable aperture 401 shown in FIG. 4, the gas and particle flow are directed in an axially-symmetric flow near the longitudinal center 501 of the housing and through the rectangular light column formed by the optical transmitter. The geometry creates a optimized light scatter zone 302 proximal or adjacent to the aerodynamic focal point of the aerodynamic lens that produces light scattered 208 by particles that enter the zone 302.

The most probable direction of scattered light can be predicted by particle size, particle make-up (index of refraction), and the laser wavelength, for example, as described by the Mie scattering theory as depicted in FIG. 5B. Curves of scatter light intensity distribution as a function of scatter angle from the light path generated by the optical transmitter for wavelengths of 1,600 nm 510, 400 nm 512, 300 nm 514 and 200 nm 516 are shown. Application of the Mie theory scatter intensity angular distribution data implies that a design angle, α, of about 30 degrees for the angular separation of the axis of light beam transmission from the optical transmitter 109 and the orientation axis of the optical receiver 200 as shown in FIG. 2B.

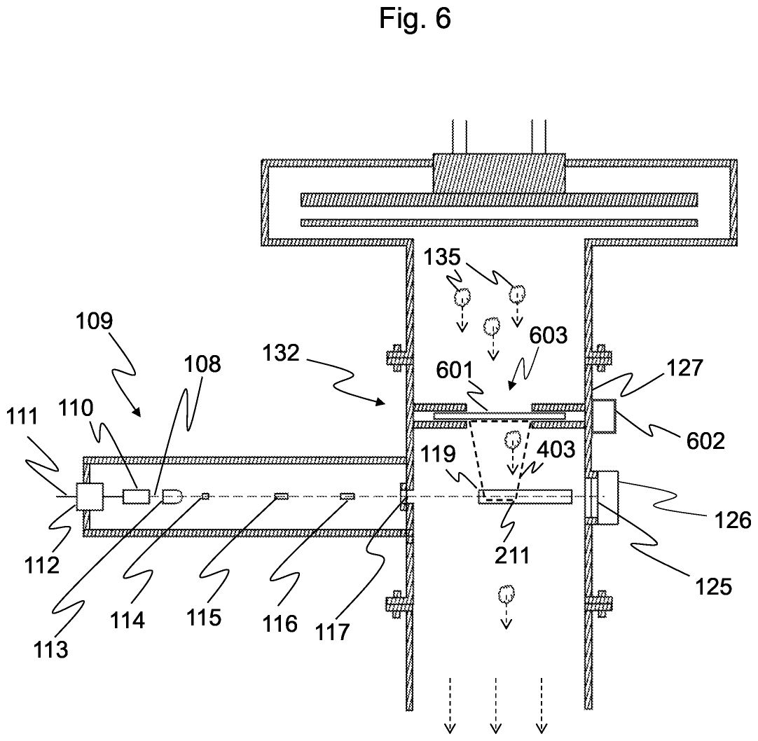

FIG. 6 shows an exemplary embodiment longitudinal cross-sectional drawing of a combined throttling element particle detector 132. A throttling element is disposed in the housing 127, in this embodiment shown as adjustable gate valve with a maximal opening constrained by the dimensions of a rectangular opening and an adjustable member 601 that can be articulated to open or close the aperture formed by the gate rectangular slit that enables a changeable aperture. An optical particle detection system comprising an optical transmitter 109 and optical receiver (not shown) are disposed in optical communication with the combined throttling particle detector fixed to the housing 127. A light source 110 in communication with an outside through a conductor 112 and a connector 111 is secured in the optical transmitter. Light 108 emitted by the light source 110 traverses a series of optical components; for example, in the embodiment shown in FIG. 4, light passes through a sequence of lenses 113 and mirrors 114, such as a Powell lens 115 and a cylindrical lens 116, designed to focus and shape the light beam into a column that passes into the housing of the combined throttling element particle detector housing 127 through an optical window 117. The optical window 119 is designed to have a shape consistent with receiving light scattered by particles traversing the region proximal to the receiver optical window 119 with a window width selected according to the design dimensions of the aerodynamic aperture of the throttling element 603. Opposite the optical transmitter window 117 is disposed an optical window 125 for receiving unscattered light from the optical transmitter 109 to a beam dump 126 or equivalent device for absorbing light energy.

The adjustable aperture formed by the adjustable gate valve 603 slit generates an aerodynamic lens 403 with a focal point 211 proximal to the rectangular light path emanating from the optical transmitter 109 optionally controlled by a actuator control 602. The spatial intersection between the aerodynamic lens 403 near its focal point 211 produces a scattering zone that, by design, improves the collection of light scattered by particles 135 traversing the aperture formed by the adjustable aperture 601 and entering the scatter zone near the aerodynamic leans focal point 211.

A particle detector according to the Application can alternatively be installed in a bypass pipe that is parallel with the pipe of a primary throttle valve.

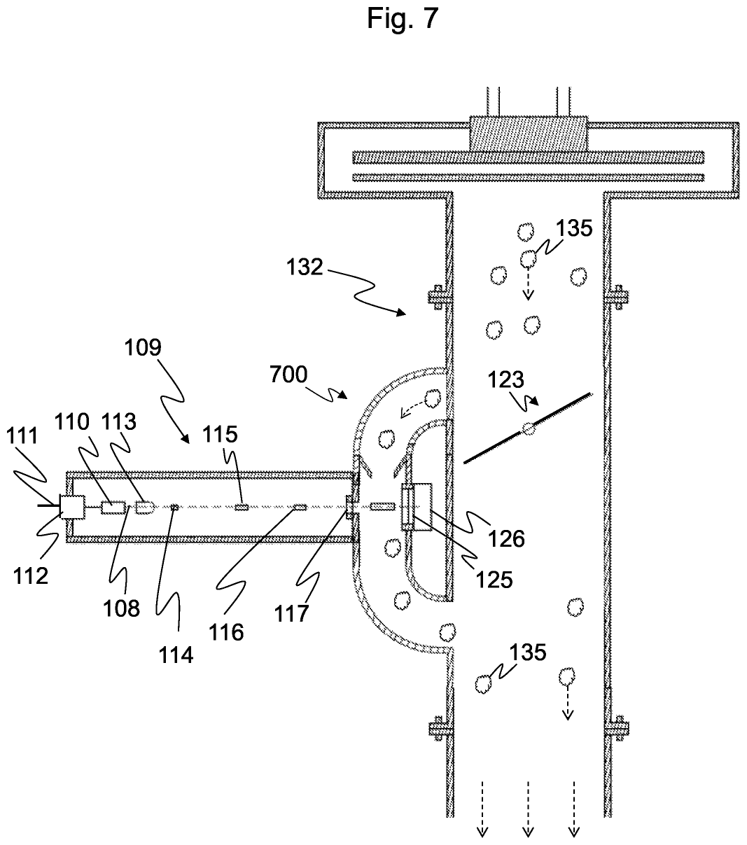

Example—FIG. 7 is a drawing showing a cut away section view diagram of a combined throttling element particle detector 132 according to the Application in a bypass configuration. Similar to the particle detector of FIG. 1, a light source 110 in communication with an outside through a conductor 112 and a connector 111 is secured in the optical transmitter 109. Light 108 emitted by the light source 110 traverses a series of optical components; for example, in the embodiment shown in FIG. 5A, light passes through a sequence of lenses 113 and minors 114, such as a Powell lens 115 and a cylindrical lens 116, designed to focus and shape the light beam into a rectangular column that passes into the housing of the combined throttling element particle detector housing 127 through an optical window 117. An aerodynamic lens, now in a bypass pipe 700 in parallel with a main butterfly valve 123, provides the throttling element of the exemplary bypass detector. Beam dump 126 reduces scattered light from the ribbon light beam past the area of detection in the aperture of the aerodynamic lens formed by the aerodynamic aperture 706. The optical receiver can be disposed in any suitable location on a wall of bypass pipe 701, typically viewing the light scattered by particles in the aperture of the aerodynamic lens through an optical window 125, such as a vacuum window (detector not shown in FIG. 7).

In this bypass configuration, a main large butterfly valve can be closed for low vacuum process pressures, which are then maintained by the conductance modifying features of the bypass line which includes the laser-based particle sensor. In some particle detectors, the bypass line can be about the right conductance to match the gas flow to the target process pressure. The bypass line can also have an adjustable throttle feature matching the laser ribbon width that can be actuated to achieve the desired conductance. A second shut-off valve can be added in series to the sensor lessening the requirements that it be leak-tight.

In the exemplary system of FIG. 7, the main butterfly valve 123 closes in a horizontal position cut away sectional view side of the main pipe. One problem with surfaces such as a butterfly valve disk which closes at a 90 degree angle with the gas flow is that particles can drop out or otherwise impact the surface. The particles falling onto a perpendicular (orthogonal) surface, are more likely to accumulate on the surface which will likely require a more frequent cleaning.

One advantage of a bypass type particle detector of FIG. 7, is that the parallel gas flow path can often be implemented in conjunction with an existing main valve. Thus, in many cases, it is possible to add a new particle detector according to an embodiment, without need to replace the relatively expensive main valve, such as the industry standard butterfly type main valve.

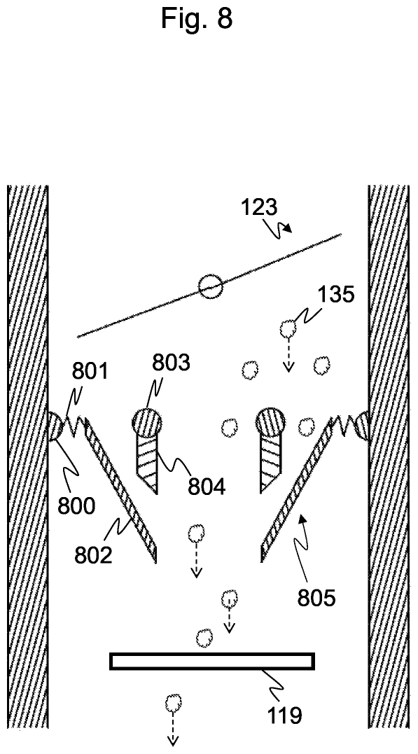

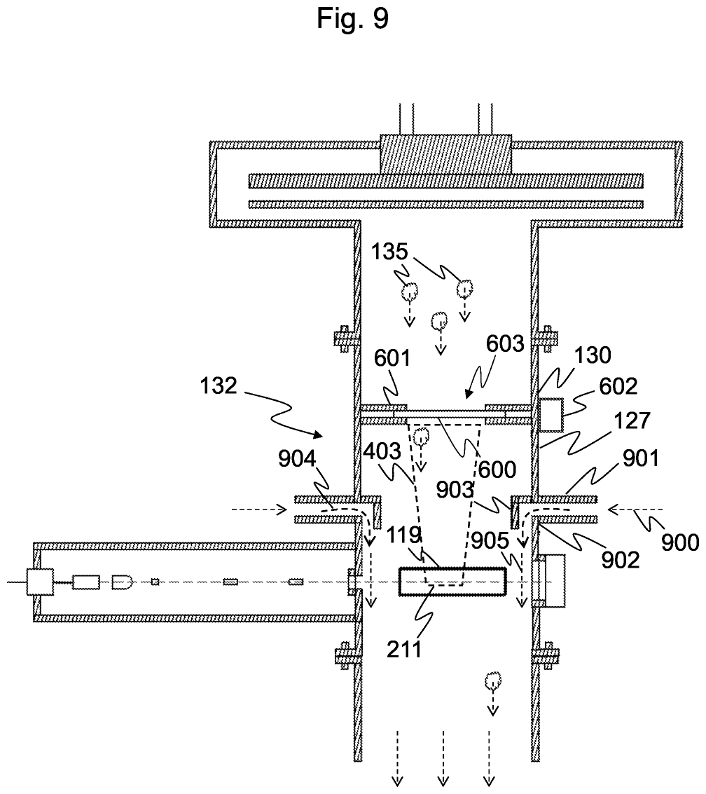

FIG. 8 shows an embodiment according to the Application with a spring-loaded limiting feature as the throttling element creating an adjustable aperture as a second throttling element to a butterfly valve 123.

Exemplary aerodynamic lens 805 has vanes spring biased by springs 801 fixed to the pipe wall 800. The exemplary channel flaps 802 cause a rectangular opening which is present in the closed position, and a larger aperture in the open position allowing gas and particles to flow pas the optical receiver window 119. The dimensions of the channel flaps 802 may be designed to fully close the aerodynamic lens against a limiting stop 804 during conditions of low gas flow. Such configurations are particularly useful where there is a large gas flow near atmospheric pressure (for example, about 760 Torr) where the vanes can be forced open by the gas flow. When pumped down, there is no longer enough gas density to hold the channel flaps 802 open, and the spring biased channel flaps then move to a spring bias closed position. Note that there can still be an open aperture for pumping at lower vacuum when the channel flaps are completely closed as determined by the gap dimension which can be set by channel flap size.

A flow limiting feature of the throttling element can be spring loaded and moved into operating position by the force of gas molecules and particles 135 impinging upon it. The flow limiting feature can open automatically when a high flow is used, such as for an initial pump out from atmospheric pressure.

A rectangular spring-loaded bypass can be used with integrated laser particle counter. The spring can be matched to the force expected for the flow and pressure expected under typical process conditions and the laser ribbon has a width greater than the channel size for high counting efficiency.

A valve and sensor configuration can also have a three-dimensional shape to make it act more like a funnel to help reduce the number of particles deposited on its surfaces and so that particles passing through can be well matched spatially with a detection laser. For example, curved iris-like elements with a conical shape, spherical or ellipsoidal shape are specifically mentioned. The throttling element can have similarly curved iris elements which curve out of the plane of the aerodynamic aperture. As discussed hereinabove, such curved surfaces, non-perpendicular to the gas flow can help to minimize particle deposition on surfaces. Similar cone structures and shapes are also suitable for either fixed, manually adjustable, or motorized or pneumatic adjustable aerodynamic lenses.

### Methods

There are also new methods of use for combined throttling element particle detector of claim 1 according to the Application. Transport of particles from the chamber to the sensor is poor under high vacuum conditions. If the throttle is closed, the pressure in the chamber can be increased. The valve can then be opened to create a pressure change by opening the valve which causes a puff of gas in the low vacuum range which transports particles to the sensor. Methods making use of a puff a gas are best performed when a wafer is not present in the process chamber, such as between the time a completed wafer is removed from the chamber and before a new wafer is inserted into the chamber. Such methods can also be used to detect a chamber cleaning endpoint.

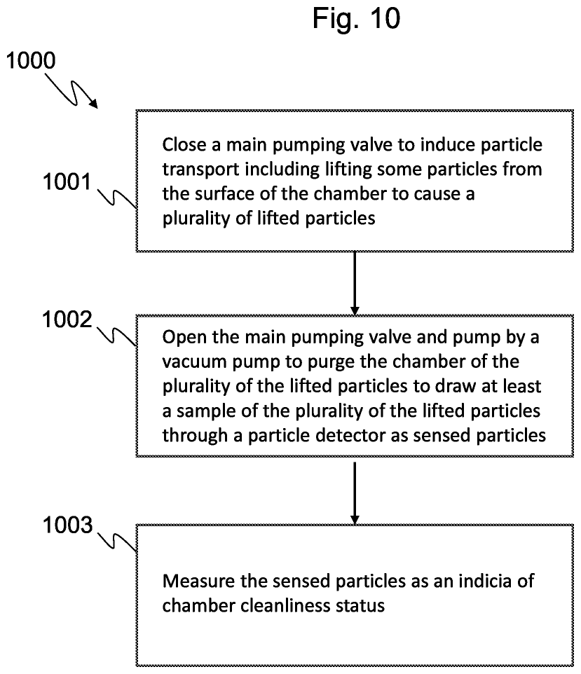

FIG. 10 is drawing showing an exemplary process for use when there is no wafer in the chamber as described hereinabove. A method 1000 for detecting and measuring particles previously deposited on a surface of a semiconductor manufacturing chamber includes: A) closing a main pumping valve to induce particle transport including lifting some particles from a surface of the chamber 1001; B) opening the main pumping valve and pumping to purge the chamber of the lifted particles to draw the lifted particles through the sensor as sensed particles 1002; and C) measuring the sensed particles as an indicia of process chamber cleanliness status 1003. Thus, there is a synergy between the primary throttling element, the vacuum pump, and the particle sensor which allows measurement of already deposited particles that would not have otherwise been detected or counted.

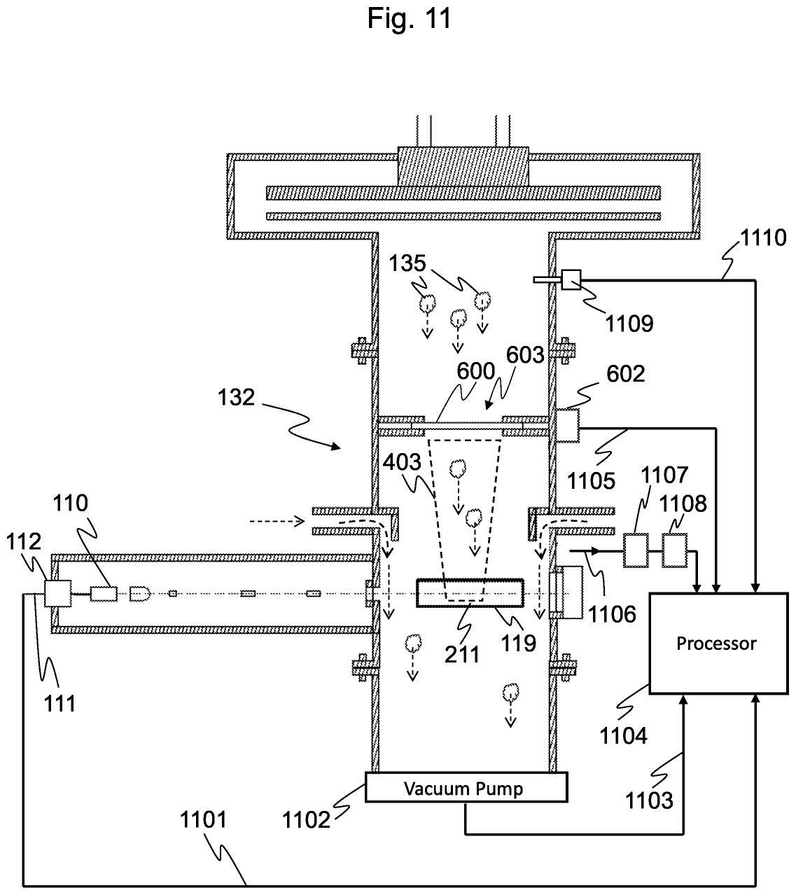

In summary, FIG. 11 is a drawing showing a combined throttling element particle detector 132 according the Application. The particle detector includes at least one throttling element shown as a gate value 603 in the FIG. 11 exemplary embodiment which defines a variable aerodynamic aperture 600. A light source 110 illuminates a region of the aerodynamic aperture 600 at about a focal point 211 of an aerodynamic lens 403. A detector (not shown) is configured to receive a light scattered from one or more particles 135 that traverse the aerodynamic aperture 600 and flow past the optical window 119.

Embodiments of combined throttling element particle detector as described hereinabove, may also include electronics, such as, for example, an optional analog to digital converter 1107 connected 1106 to an optical detector (not shown) such as a photomultiplier tube (PMT), and optional conditioning circuitry 1108 operatively coupled to a processor 1104. Some alternative types of suitable detectors can include integral electronics which provide a digital output. Any suitable analog or digital detector can be used for optical detection of the particle flow past the detector window 119. Processor 1104 may also be operatively coupled 1110 to a pressure sensor 1109 in the pipe disposed between the process chamber and the combined throttling element particle detector; to the actuator 602 through connection 1105 used to adjust a throttling element 603; and a light source 110 through the electrical connection 111 to the light source coupler 112 operating through a conductor 1101; and through a connection 1103 to a vacuum pump 1102, or similar functional equivalents, to name only one possible combination of sensor, actuator and control components. Processor 1104 may further be configured to run a software process to generate particle information based on data received 1106 from the optical detector (not shown). Optionally, processor 1104 can also control any suitable parameters of light source 110, including any adjustable optics in the optical path of light source 110, such as beam size, beam shape, beam width, beam focus, beam intensity, to name only a few exemplary operational parameters. In the case of an adjustable aerodynamic aperture such as 600 illustrated in the embodiment shown in FIG. 11, processor 1104 can also be used to control any suitable parameters of the aerodynamic lens 403, such as, for example, aerodynamic aperture 600 opening size and shape, to name only two exemplary parameters.

Software to model and operation a new particle detector according to the Application, including new processes can be supplied on a computer readable non-transitory storage medium. A computer readable non-transitory storage medium as non-transitory data storage includes any data stored on any suitable media in a non-fleeting manner. Such data storage includes any suitable computer readable non-transitory storage medium, including, but not limited to hard drives, non-volatile random-access memory (RAM), solid state drive (SSD) devices, or the functional equivalents.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

The disclosed system can alternately comprise, consist of, or consist essentially of, any appropriate components herein disclosed. The disclosed system can additionally be substantially free of any components or materials used in the prior art that are not necessary to the achievement of the function and/or objectives of the present disclosure.

The terms “a” and “an” do not denote a limitation of quantity, but rather denote the presence of at least one of the referenced item. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

What is claimed is:

1. A combined throttling element particle detector comprising:
at least one throttling element which defines an aerodynamic aperture;
a light source illuminates a region of said aerodynamic aperture at about a focal point of an aerodynamic lens; and
a detector configured to receive a light scattered from one or more particles which traverse said aerodynamic aperture.

2. The combined throttling element particle detector of claim 1, further comprising a section of pipe, said at least one throttling element disposed within said section of pipe, said light source mechanically coupled to a wall of said section of pipe and optically coupled via a window to said aerodynamic aperture, said detector mechanically coupled to said wall of said section of pipe and optically coupled via a detector window to receive light from one or more particles as they pass through said aerodynamic aperture.

3. The combined throttling element particle detector of claim 2, wherein said pipe comprises a mounting assembly that connects a first end of said pipe to a process chamber and connects a second end of said pipe to a vacuum pump system.

4. The combined throttling element particle detector of claim 1, wherein said aerodynamic lens comprises a plurality of apertures.

5. The combined throttling element particle detector of claim 1, wherein said light source comprises low-divergence light column formed into a rectangular ribbon shape of light.

6. The combined throttling element particle detector of claim 1, wherein said light source comprises a laser light formed into a rectangular ribbon shape of light.

7. The combined throttling element particle detector of claim 1, wherein said light source is about proximal to said at least one throttling element.

8. The combined throttling element particle detector of claim 1, wherein said detector is disposed about adjacent to said at least one throttling element.

9. The combined throttling element particle detector of claim 1, wherein said at least one throttling element comprises a series of two or more plates with said aerodynamic aperture defined by at least one separation between two or more plates.

10. The combined throttling element particle detector of claim 1, wherein said at least one throttling element comprises said aerodynamic aperture defined by a variable aperture device.

11. The combined throttling element particle detector of claim 10, wherein said variable aperture device comprises an iris valve.

12. The combined throttling element particle detector of claim 10, wherein said variable aperture device comprises an iris valve including leaves of said iris valve which curve out of a plane defined by said aerodynamic aperture of said iris valve.

13. The combined throttling element particle detector of claim 10, wherein said variable aperture device comprises a butterfly valve.

14. The combined throttling element particle detector of claim 10, wherein said variable aperture device comprises a gate valve.

15. The combined throttling element particle detector of claim 10, wherein said variable aperture device comprises a vane valve, at least one vane of said vane valve spring biased to a closed position and wherein said at least one vane opens by a gas flow through said vane valve, and wherein in said closed position there remains an open aerodynamic aperture.

16. The combined throttling element particle detector of claim 1, wherein said particle detector is disposed in gas flow series with a different main process valve.

17. The combined throttling element particle detector of claim 1, wherein said particle detector is disposed in gas flow parallel with the primary throttling element, said particle detector disposed in a bypass pipe around a different main process throttling element.

18. The combined throttling element particle detector of claim 1 further comprising:
at least one throttling element which defines an aerodynamic aperture;
a light source in combination with a scanning minor illuminates a region of said aerodynamic aperture at a focal point of an aerodynamic lens; and
a detector configured to receive a light scattered from one or more particles which traverse said aerodynamic aperture.

19. A method of making a particle count measurement wherein,
an adjustable throttling aperture is opened full;
a background particle detection measurement is recorded;
the said adjustable throttling aperture is partially closed adding process gases to achieve a target pressure process chamber while forming an aerodynamic focus;
making a particle count measurement proximal to the aerodynamic focus; and
subtracting the background to provide a corrected particle count.

20. A method for detecting and measuring particles previously deposited on a surface of a semiconductor process chamber comprising:
closing a main pumping valve to induce particle transport including lifting some particles from said surface of the chamber to cause a plurality of lifted particles;
opening said main pumping valve and pumping by a vacuum pump to purge the chamber of said plurality of said lifted particles to draw at least some of said plurality of said lifted particles through a particle detector as sensed particles; and
measuring the sensed particles as an indicia of chamber cleanliness health.
